(19) United States
(12) Patent Application Publication
(10) Pub. No.: US 2026/0228000 A1
(43) Pub. Date: Aug. 6, 2026

(54) ARITHMETIC LOGIC UNIT, PROCESSOR COMPRISING THE SAME, AND METHOD FOR DRIVING THE PROCESSOR

(71) Applicant: Samsung Electronics Co., Ltd., Suwon-si (KR)

(72) Inventors: Jaehwan JUNG, Suwon-si (KR); Heehyun NAM, Suwon-si (KR); Dongmin LEE, Suwon-si (KR); Ranhee LEE, Suwon-si (KR); Youngseob CHOI, Suwon-si (KR)

(73) Assignee: Samsung Electronics Co., Ltd., Suwon-si (KR)

(21) Appl. No.: 19/282,661

(22) Filed: Jul. 28, 2025

(30) Foreign Application Priority Data
Feb. 6, 2025 (KR) 10-2025-0014867

(51) Int. Cl. G06F 9/30; G06F 5/01; G06F 11/14

(52) U.S. Cl. CPC G06F 9/3001; G06F 5/01; G06F 11/14

(57) ABSTRACT

An arithmetic logic unit receives first user data included in a first operand and second user data included in a second operand, performs a linear operation on the first user data and the second user data, and outputs a user data result value of the linear operation, and an incremental parity calculator which receives a first parity included in the first operand and a second parity included in the second operand, performs an incremental parity operation on the first parity and the second parity, and outputs a parity result value of the incremental parity operation. The first parity is generated by performing error correction encoding on the first user data, the second parity is generated by performing the error correction encoding on the second user data, and the parity result value is generated by performing the error correction encoding on the user data result value.

### CROSS-REFERENCE TO RELATED APPLICATION(S)

This U.S. non-provisional application claims priority under 35 U.S.C. § 119 to Korean Patent Application No. 10-2025-0014867 filed on Feb. 6, 2025, in the Korean Intellectual Property Office, the entire disclosure of which is incorporated herein by reference.

### BACKGROUND

Example embodiments relate to an arithmetic logic unit, a processor including the same, and a method of operating the processor.

The processor may read instructions stored in memory, execute operations on the operands according to the corresponding instructions, and store the results in the memory. In applications that benefit from higher degrees of intelligence and precision, such as autonomous driving or aerospace vehicles, fault-tolerant processors may be used to maintain the sufficient integrity and stability of the system. Fault-tolerant processors may find and recover unintended errors in a timely manner (e.g., as the errors are detected) even if the errors occur during data processing. The processors may find and recover unintended errors using error checking functions such as parity check using error correction codes (ECC). However, if the ECC parity check operation is performed repeatedly, an operating speed of the processor may decrease.

### SUMMARY

Some example embodiments provide a fault-tolerant high-speed processor configured to perform operations at relatively higher speed and/or maintain (or provide) data security by performing incremental parity operations while performing linear operations in an arithmetic logic unit.

According to some example embodiments, an arithmetic logic unit includes a user data operator configured to receive a first user data included in a first operand, and a second user data included in a second operand, perform a linear operation on the first user data and the second user data, and output a user data result value of the linear operation; and an incremental parity calculator configured to receive a first parity included in the first operand and a second parity included in the second operand, perform an incremental parity operation on the first parity and the second parity, and output a parity result value based on the incremental parity operation. The first parity is generated by performing error correction encoding on the first user data, the second parity is generated by performing the error correction encoding on the second user data, the parity result value is generated by performing the error correction encoding on the user data result value, and the incremental parity operation is performed while the linear operation is being performed.

According to some example embodiments, a processor includes an arithmetic logic unit configured to receive a first operand and a second operand and output an operation result value; and an error correction coder including an encoder configured to perform error correction encoding and a decoder configured to perform error correction decoding. The arithmetic logic unit is configured to perform an incremental parity operation on a first parity included in the first operand and a second parity included in the second operand, and output a linear operation result and a result of the incremental parity operation as the operation result value while performing a linear operation on first user data included in the first operand and second user data included in the second operand. The first parity is generated by error correction encoding the first user data, and the second parity is generated by error correction encoding the second user data.

According to some example embodiments, a method of operating a processor includes performing error correction decoding of a first operand using a first parity included in the first operand and performing error correction decoding of a second operand using a second parity included in the second operand; performing a linear operation on a first user data included in the first operand and a second user data included in the second operand; performing an incremental parity operation on the first parity and the second parity while performing the linear operation; and combining a user data result value which is a result of the linear operation and a parity result value which is a result of the incremental parity operation to output an operation result value. The first parity is generated by error correction encoding on the first user data, the second parity is generated by error correction encoding on the second user data, and the parity result value is generated by error correction encoding on the user data result value.

According to some example embodiments, a system includes a memory; and at least one CPU core communicably coupled to the memory and including an arithmetic logic unit. The arithmetic logic unit includes a user data operator configured to receive a first user data included in a first operand and a second user data included in a second operand, perform a linear operation on the first user data and the second user data, and output a user data result value of the linear operation; and an incremental parity calculator configured to receive a first parity included in the first operand and a second parity included in the second operand, perform an incremental parity operation on the first parity and the second parity, and output a parity result value based on the incremental parity operation. The first parity is generated by performing error correction encoding on the first user data. The second parity is generated by performing the error correction encoding on the second user data. The parity result value is generated by performing the error correction encoding on the user data result value. The incremental parity operation is performed while the linear operation is being performed. According to some example embodiments, the arithmetic logic unit further includes a concatenator configured to receive the parity result value and the user data result value and output an operation result value including the parity result value and the user data result value. According to some example embodiments, the linear operation includes arithmetic operations and a shift operation. According to some example embodiments, the first user data and the second user data are integers. According to some example embodiments, the error correction encoding is performed by a linear block code.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a block diagram of a CPU according to some example embodiments.

FIG. 2 illustrates a part of a system according to some example embodiments.

FIG. 3 and FIG. 4 illustrate a data path of a CPU core according to some example embodiments.

FIG. 5 illustrates the configuration of encoded data according to some example embodiments.

FIGS. 6, 7, and 8 illustrate the operation of an arithmetic logic unit according to some example embodiments.

FIGS. 9A and 9B are timing diagrams illustrating the linear operation and incremental parity operation of an arithmetic logic unit according to some example embodiments.

FIG. 10 is a flowchart illustrating the operation of a processor processing data according to some example embodiments.

FIG. 11 is a flowchart illustrating the operation of an arithmetic logic unit according to some example embodiments.

FIG. 12 illustrates the configuration of a system according to some example embodiments.

### DETAILED DESCRIPTION

Hereinafter, example embodiments will be described with reference to the accompanying drawings.

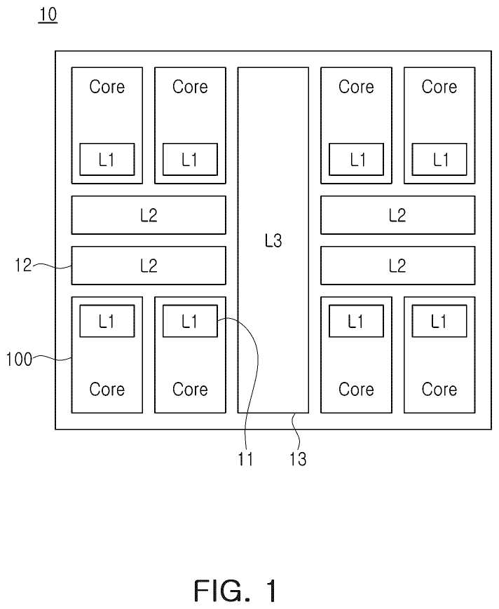

FIG. 1 is a block diagram of a CPU according to some example embodiments. FIG. 1 illustrates a multi-core CPU 10 having eight cores, but the number of CPU cores 100 is not limited thereto.

Referring to FIG. 1, a Central Processing Unit (CPU) 10 according to some example embodiments may include at least one CPU core 100 and at least one cache memory 11, 12, 13. The CPU 10 may control and adjust the overall operation of a system, such as receiving and processing data from an external device, transmitting the processing result to the external device, and controlling a series of such processes. The CPU 10 may serve or operate as an interface between system software and hardware components.

Various commands may be defined for the CPU 10 to control the system. The CPU 10 may have an instruction set architecture (ISA), which is a set of such commands, and may have a microarchitecture of various hardware structures based on the ISA. In some example embodiments, the ISA may be designed based on a Complex Instruction Set Computer (CISC) or Reduced Instruction Set Computer (RISC) design method. For example, the ISA included in the CPU 10 may be x86, Advanced RISC Machine (ARM), or Microprocessor without Interlocked Pipeline Stages (MIPS). However, the type of ISA is not limited thereto.

According to some example embodiments, the CPU 10 may be a single core processor including a single CPU core 100, or a multi-core processor including multiple CPU cores 100 (as illustrated in FIG. 1). One CPU core 100 may independently execute instructions within the CPU 10. A multi-core processor may execute multiple instructions in parallel and simultaneously.

The cache memory 11, 12, and 13 may temporarily store data to be input from an external device or output to an external device. The cache memory 11, 12, and 13 may compensate for the speed difference between the CPU 10 operating at relatively higher speed and the external device processing data at a relatively lower speed. In some example embodiments, the cache memory 11, 12, and 13 may include multiple lower cache memories. The multiple lower cache memories may be divided into layers according to the physical distance from the CPU core and the speed thereof.

For example, the cache memory 11, 12, and 13 may include an L1 cache memory 11 inside the CPU core 100 and an L2 cache memory 12 and an L3 cache memory 13 outside the CPU core 100. The L1 cache memory 11 may be a cache memory directly integrated into the CPU core 100. The L1 cache memory 11 is physically closest to the CPU core 100, operates at the same or similar speed as the CPU core 100, and may have the smallest capacity among the cache memories 11, 12, and 13. The L2 cache memory 12 may be physically located between the L1 cache memory 11 and the main memory. The L2 cache memory 12 may provide additional storage for data and instructions. The L3 cache memory 13 may share data between all the CPU cores 100 in the processor, thereby enabling more efficient communication between the CPU cores 100. The L3 cache memory 13 may be slower in operation speed than the L1 cache memory 11 and the L2 cache memory 12, but may be faster than the operation speed of the main memory of the system. However, the hierarchical structure of the cache memory 11, 12, 13 included in the CPU 10 is not limited thereto, and, in some example embodiments, the CPU 10 may include more than 3 cache memories.

The CPU core 100 may include a pipeline data path including a plurality of stages, each of which may be performed in parallel, to process a plurality of instructions with a relatively higher efficiency. The pipeline data path may include pipeline registers for transferring data between the plurality of stages. To maintain sufficient integrity in each stage, data input to the pipeline register may be error correction code (ECC) encoded, and data output from the pipeline register may be ECC decoded. The encoding and decoding may delay the time required for each stage. For example, a relatively longer time may be required in the pipeline data path in the execution stage where an operation is performed. Performing encoding on data for which an operation has been completed in the execution stage may further delay the time required for the stage, and may cause a bottleneck in the pipeline data path.

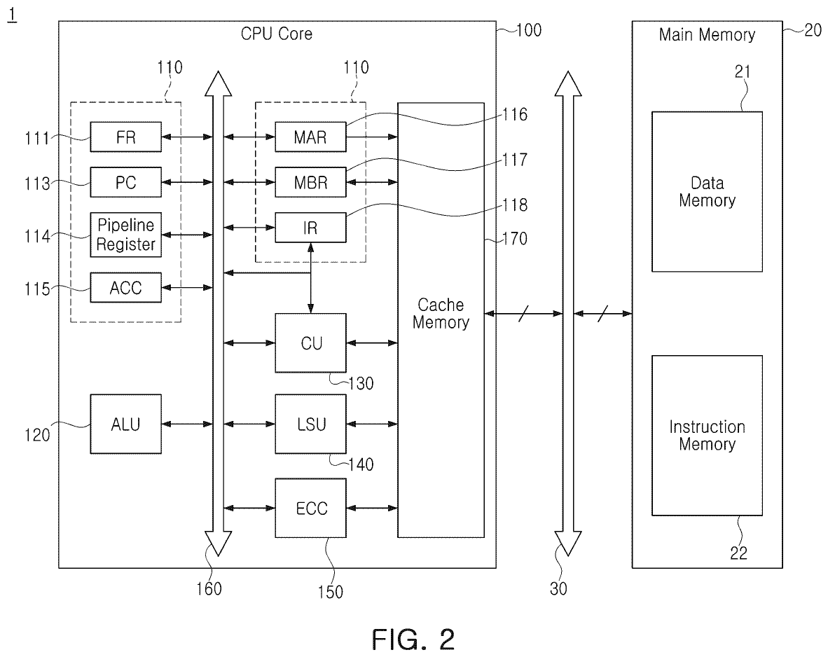

According to some example embodiments, the CPU core 100 may reduce the time required for the execution phase by pre-calculating the parity result value of the operation result while the operation for the operand is performed in the execution phase. First, a system including the CPU core 100 and the pipeline data path of the system will be described in detail with reference to FIGS. 2 to 4.

FIG. 2 illustrates a part of the system according to some example embodiments.

Referring to FIG. 2, the system 1 according to some example embodiments may include at least one CPU core 100, a main memory 20, and a system bus 30, and the like. The CPU core 100 may be the CPU core 100 described above with reference to FIG. 1. The CPU core 100 may include a control unit (CU) 130, an arithmetic logic unit (ALU) 120, a plurality of registers 110, a load/store unit (LSU) 140, an error correction coder (ECC) 150, a cache memory 170, and an internal bus 160.

The register 110 may store data within the CPU core 100. The register 110 may include a program counter (PC) 113, an instruction register (IR) 118, a memory address register (MAR) 116, a memory buffer register (MBR) 117, a flag register (FR) 111, an accumulator (ACC) 115, a pipeline register 114, and the like.

The PC 113 may read and store an instruction to be executed after the instruction currently being executed by the CPU core 100 from the main memory 20. The IR 118 may read and store an instruction currently being executed by the CPU core 100 from the main memory 20. The MAR 116 may temporarily store an address value when the CPU 10 uses an address bus among the system buses 30. The MBR 117 may temporarily store instructions or data when the CPU core 100 sends and receives data through the data bus of the system bus 30. The instruction stored in the MBR 117 may be transferred to the IR 118, and the data stored in the MBR 117 may be transferred to a location (e.g., to a component of the system at the location) that requested the data according to the command of the CU 130. The FR 111 may store additional information on the operation result of the ALU 120, for example, information on the sign of the operation result or whether there is an overflow. The ACC 115 may temporarily store the operation result of the ALU 120 to compensate for the difference in access speed between the external main memory 20 and the register 110. The pipeline register 114 may distinguish between pipeline stages and temporarily store or transmit intermediate data between pipeline stages at high speed.

According to some example embodiments, the register 110 may further include various types such as a stack pointer (SP) used in a stack addressing method, a base register (BR) used in a displacement addressing method, a general purpose register (GPR) used to freely store other data, addresses, and the like., an input/output address register (IOAR), an input/output buffer register (IOBR), and the like.

The CU 130 may output a control signal to read or store data stored in the main memory 20 or input/output values of an input/output device from outside the CPU core 100. The CU 130 may output a control signal inside or outside the CPU core 100 so that multiple micro-operations are executed within the CPU core 100. For example, the micro-operations may include operations such as data transfer between registers 110, data transfer between registers 110 and a system bus 30, and ALU 120 operations. For example, the CU 130 may output a control signal that instructs the ALU 120 to perform an operation, send a control signal for data movement between registers 110, and output a control signal to read a value stored in the main memory 20 or store a new value.

The ALU 120 may perform various operations according to the command of the CU 130. The ALU 120 may receive an operand from the register 110 and an opcode corresponding to an operator from the CU 130. The ALU 120 may perform an arithmetic operation using the input operand and opcode. For example, the ALU 120 may perform arithmetic operations such as addition, subtraction, multiplication, and division. As another example, the ALU 120 may perform logical operations such as AND, OR, XOR, NOT, NAND, and NOR. As another example, the ALU 120 may perform operations such as relational operations and shift.

The LSU 140 may exchange data between the main memory 20 and the register 110 during the instruction processing process. The LSU 140 may read data from the main memory 20 and load (or store or save) it into the register 110, or store data from the register 110 into the main memory 20. The LSU 140 may exchange data with the cache memory 170, or communicate directly with the main memory 20.

The ECC 150 may detect and correct single-bit errors or multi-bit errors that may occur during the process of transmitting or storing data. The ECC 150 may include an encoder that calculates parity to protect data, and a decoder that detects and corrects data errors using the parity. For example, the ECC 150 may be implemented as an encoder circuit and a decoder circuit. The ECC 150 may detect errors occurring in data in the register 110, cache memory 170, data transmission path, and the like within the CPU core 100, and correct them. For example, ECC may be a linear block code such as Hamming Code, Single Error Correction-Double Error Detection (SEC-DED), Bose-Chaudhuri-Hocquenghem (BCH), and the like. However, the type of ECC is not limited thereto.

When a program (e.g., computer-readable instructions or program code) is executed, the main memory 20 may load a program or data from an auxiliary or external memory device. The main memory 20 may include an instruction (or command) memory 22 and a data memory 21 depending on the type of data to be stored. In addition, the main memory 20 may include one or more volatile memories and/or one or more non-volatile memories depending on the physical configuration. Volatile memory is a semiconductor device in which all contents are erased when power is turned off, and may include, for example, Dynamic Random Access Memory (DRAM), Synchronous Random Access Memory (SDRAM), and the like. Nonvolatile memory is a semiconductor device that retains stored content even when power is cut off, and may include, for example, Read Only Memory (ROM), flash memory (for example, NOR Flash Memory, NAND Flash Memory), Programmable ROM (PROM), Electrically Programmable ROM (EPROM), Electrically Erasable and Programmable ROM (EEPROM), Phase-change RAM (PRAM), Resistive RAM (RRAM), Ferroelectric RAM (FeRAM), Magnetic RAM (MRAM), and the like.

The instruction memory 22 may store instructions to be executed by the CPU core 100, such as codes of executable files, call functions, and operation instructions. The instructions may be read through the PC 113. While the instructions are being executed through the PC 113, the CPU core 100 may read or modify data and store it in the data memory 21.

The cache memory 170 may temporarily store data that is input or received from an external device or output to an external device. The cache memory 170 may be the L1 cache memory 11 described above with reference to FIG. 1. The cache memory 170 may include an instruction cache and a data cache. According to some example embodiments, a cache memory 12, 13 described above with reference to FIG. 1 may be further arranged between the cache memory 170 and the system bus 30. In some example embodiments, the instruction cache may temporarily store instruction data stored in the instruction memory 22, and the CU 130 may receive the instruction data stored in the instruction cache instead of the instruction memory 22.

The system bus 30 may provide a communication path between components of the system 1. The components of the system 1 may exchange data according to the bus format of the system bus 30. For example, the system bus 30 may support one or more interface standards, such as Peripheral Component Interconnect Express (PCIe), Nonvolatile Memory Express (NVMe), Universal Flash Storage (UFS), Serial Advanced Technology Attachment (SATA), Small Computer System Interface (SCSI), Serial Attached SCSI (SAS), Generation-Z (Gen-Z), Cache Coherent Interconnect for Accelerators (CCIX), and Open Coherent Accelerator Processor Interface (OpenCAPI).

The system bus 30 may include an address bus, a data bus, and a control bus. The address bus may serve as a passage for transmitting an address from the CPU core 100 to the main memory 20, or for exchanging port numbers with an input/output device. The data bus may serve as a passage for exchanging commands or data between the CPU core 100, the main memory 20, and the input/output device. The control bus may serve as a passage for transmitting control signals to control the data bus, the address bus, and the like.

In some example embodiments, when the CPU core 100 performs a load command (for example, memory load), the address bus may transfer an address value where data to be read from the main memory 20 is stored from the CPU core 100 to the main memory 20. The control bus may transfer a load signal from the CPU core 100 to the main memory 20. The data bus may transfer data stored in the main memory 20 from the main memory 20 to the CPU core 100. In some example embodiments, when the CPU performs a store command (for example, register store or memory store), the address bus may transfer an address value where data is to be stored in the main memory 20 from the main memory 20 to the CPU core 100. The control bus may transfer a control signal from the CPU core 100 to the main memory 20. The data bus may transfer data to be stored in the main memory 20 from the CPU core 100 to the main memory 20.

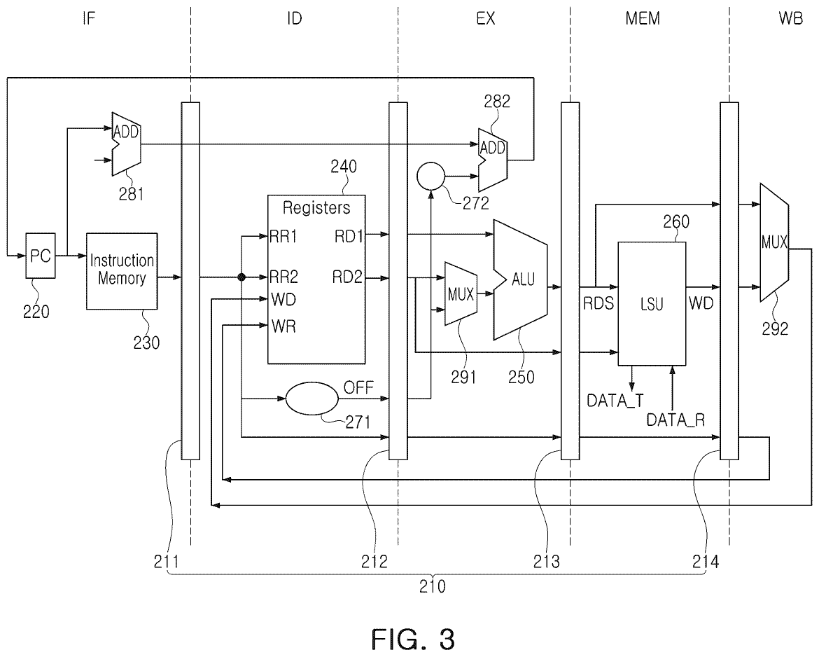

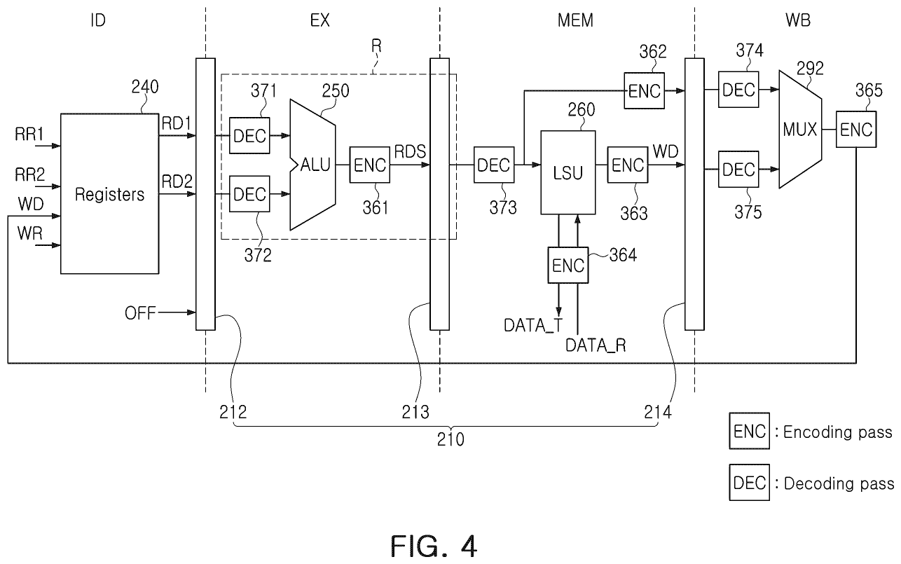

FIG. 3 and FIG. 4 illustrate the data path of the CPU core according to some example embodiments. FIG. 3 and FIG. 4 illustrate the pipeline data path by taking the case where the CPU is designed with MIPS ISA as an example, but the ISA and hardware structure of the CPU are not limited thereto.

The data path may be or include a set of components that process or transmit data and addresses within the CPU. These components may perform operations such as processing data or accessing memory and/or registers to input/output data and addresses to perform operations for the process of executing instructions.

In some example embodiments, to improve the performance of the CPU, the CPU core may be designed to perform a series of operations for executing instructions simultaneously by dividing them into several stages. Multiple operations for executing one instruction in the CPU core may be separated into stages and pipelined. All stages of the pipeline may be synchronized based on a clock signal and performed during the same time (for example, one cycle of the clock signal). Pipelining the operations performed in the CPU core allows for the non-overlapping stages of multiple instructions to be performed simultaneously, thereby allowing more instructions to be executed in a shorter period of time.

Referring to FIG. 3, the data path of the CPU core according to some example embodiments may divide a series of operations for executing an instruction into an instruction fetch IF stage, an instruction decode ID stage, an execution EX stage, a memory access MEM stage, and a write back WB stage. In some example embodiments, the instruction may include a memory load instruction that fetches data from a data memory and loads it into a register, a memory store instruction that stores data in the data memory, or a register store instruction that stores an operation result in a register.

In the IF stage, an operation of fetching an instruction for an arithmetic operation from the main memory may be performed. The PC 220 may transfer the address of the instruction to be currently executed to the instruction memory 230 and fetch the instruction stored at the corresponding address from the instruction memory 230. In some example embodiments, if the instruction requested by the PC 220 is stored in the cache memory of the CPU, the instruction may be retrieved from the cache memory instead of the instruction memory 230.

In some example embodiments, if the instruction is a register store instruction, the instruction may include an opcode, a source register address RR1, RR2 that provides read data, a write register address WR that will store the operation result, and the like. In some example embodiments, if the instruction is a memory store instruction or a memory load instruction, the instruction may include an opcode, a source register address RR1 that provides a base address, a write register address WR that will store write data WD, an offset OFF, and the like.

In the ID stage, an operation of retrieving an operand used for the operation based on the instruction may be performed. The register 240 may receive a command signal from the instruction memory 230. The command signal may be decoded and separated into an opcode and data for the operand. The register 240 may receive data for the operand and output the operand. The ALU 250 may receive control signals and operands corresponding to opcodes.

In some example embodiments, when the instruction is a register store instruction, data for the operand may include addresses RR1, RR2 of source registers where read data RD1, RD2 are stored. Among the plurality of registers 240, the source register may be requested for the operand RD1, RD2. Each of the source registers may output the first read data RD1 and the second read data RD2 by the request.

In some example embodiments, when the instruction is a memory load instruction or a memory store instruction, data for the operand may include address of source registers RR1 providing a base address and offset OFF. The offset OFF may be a value for calculating a destination address and may be a relative distance between the base address and the destination address. The destination address may correspond to an address of data to be loaded from memory or an address for storing data in memory. The destination address may be a value obtained by adding the offset OFF to the base address. The size of the offset OFF may be expanded in a sign expander 271 to calculate the destination address. For example, if the size of the address is 32 bits and the size of the offset OFF is 16 bits, the size of the offset OFF may be expanded to 32 bits in the sign expander 271.

In the EX stage, an arithmetic operation may be performed. The ALU 250 may receive an operand. The ALU 250 may perform an arithmetic operation, a logical operation, a relational operation, a shift operation, and the like. based on the input opcode and the operand.

The multiplexer 291 may select an operand to be input to the ALU 250 according to the instruction. For example, if the instruction is a memory load (or save) instruction or a memory store instruction, the multiplexer 291 may input an extended offset OFF to the ALU 250. the ALU 250 may receive a base address from a source register as the first read data RD1, add the base address and the extended offset OFF, and output the destination address. In some example embodiments, if the instruction is a register load, the multiplexer 291 may input the second read data RD2 output from the source register to the ALU. For example, the ALU 250 may perform an operation of calculating the first read data RD1 and the second read data RD2 input from the source register.

In the MEM stage, an operation of transmitting or storing the operation result value RDS to the memory may be performed. In some example embodiments, if the instruction is a register store instruction, the MEM stage may be omitted. In some example embodiments, if the instruction is a memory load instruction, the transfer data DATA_T including the operation result value RDS calculated through the arithmetic operation and the second read data RD2 output from the register 240 may be transmitted to the data memory, and the data memory may store the second read data RD2 at an address corresponding to the operation result value RDS. In some example embodiments, if the instruction is a memory store, the LSU 260 may transmit transmission data DATA_T including the operation result value RDS calculated through the arithmetic operation to the data memory, and may receive reception data DATA_R including the write data WD stored at the address pointed to by the operation result value RDS from the data memory.

In the WB stage, the operation result may be written back and input into the register. In some example embodiments, if the instruction is a memory store, the WB stage may be omitted. In some example embodiments, if the instruction is a register store instruction, the operation result value RDS calculated by the ALU 250 may be input into the register 240. In some example embodiments, if the instruction is a memory read, the write data WD output from the LSU 260 may be input into the register 240.

While a series of pipeline stages IF, ID, EX, MEM, WB are in progress according to the current instruction, an operation for preparing the next instruction may be performed simultaneously. In some example embodiments, an operation may be performed to change the current instruction address stored in the PC 220 to the next instruction address. For example, if the length of the instruction is 32 bits, 4 may be added to the current instruction address in the first adder 281. As another example, if the length of the instruction is 64 bits, 8 may be added to the current instruction address in the first adder 281. In addition, the extended offset OFF in the ID stage may be converted from bit-unit data to byte-unit data through the shift circuit 272. Thereafter, the second adder 282 may calculate the final instruction address by adding the instruction address output from the first adder 281 and the offset OFF and input it to the PC 220.

Multiple pipeline stages IF, ID, EX, MEM, WB that separate the data paths may be separated by multiple pipeline registers 210. The pipeline register 210 may temporarily store intermediate data and transmit data at relatively higher speed whenever a pipeline stage passes. The IF/ID pipeline register 211 may store an instruction output from the instruction memory 230. The ID/EX pipeline register 212 may store read data RD1, RD2 and/or destination address data WR, and the like. The EX/MEM pipeline register 213 may store the operation result value RDS calculated by the ALU 250 and/or the second read data RD2, and the like. The MEM/WB pipeline register 214 may store the operation result value RDS calculated by the ALU 250 and/or the write data WD output by the LSU 260.

FIG. 4 illustrates a part of the data path described with reference to FIG. 3. FIG. 4 may be a drawing illustrating encoding passes 361, 362, 363, 364, 365 and decoding passes 371, 372, 373, 374, 375 according to a comparative example different from the example embodiment, compared to the data pass described with reference to FIG. 3.

Referring to FIG. 4, encoding passes 361, 362, 363, 364, 365 and decoding passes 371, 372, 373, 374, 375 may be performed by an encoder and decoder included in the ECC 150 described with reference to FIG. 2. Data passing through encoding passes 361, 362, 363, 364, 365 may have parity calculated to protect the data. Data passing through the decoding passes 371, 372, 373, 374, 375 may have their integrity sufficiently verified from parity. The encoding passes 361, 362, 363, 364, 365 and the decoding passes 371, 372, 373, 374, 375 are arranged before and after the pipeline register 210, so that sufficient integrity of data input to and output from the pipeline register 210 may be maintained.

One pipeline stage may be performed during one cycle of a clock signal. For example, the pipeline stages IF, ID, EX, MEM, WB may be performed in parallel during one (or single) cycle of a clock signal (e.g., on a rising edge or falling edge of the clock signal). Whenever data is input/output to each pipeline register 210, the integrity of the data may be verified in the encoding pass 361, 362, 363, 364, 365 and the decoding pass 371, 372, 373, 374, 375.

However, in the process of verifying the integrity of the data, the time for some of the pipeline stages to be performed may be delayed. For example, the EX stage, where the operation is performed in the ALU 250, may take relatively more time among the pipeline stages IF, ID, EX, MEM, WB. If the data output by the ALU 250 is to be encoded in the encoding pass 361 in order for the data to have sufficient integrity, it may take relatively longer to encode the data than the time taken for the ALU 250 to perform the operation. Accordingly, the CPU may have limitations in performing high-speed operations.

According to some example embodiments, an incremental parity operation may be performed while the operation is performed in the ALU 250. Through this, sufficient integrity of the operation result value may be maintained even if the operation result value is not re-encoded, and the time delay may be reduced. Accordingly, the processor may perform operations at relatively higher speed while maintaining the security of the data.

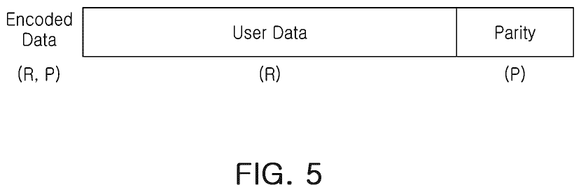

FIG. 5 illustrates the configuration of encoded data according to some example embodiments. For example, the encoded data described with reference to FIG. 5 may be data protected or encoded by an encoder of ECC, such as read data RD1, RD2 or write data WD described with reference to FIG. 3 and FIG. 4. FIG. 5 illustrates continuous user data R and continuous parity P added to the user data R. However, example embodiments are not limited thereto. For example, encoded data may be divided into user data R and parity P and the divided data may be arranged crosswise. However, the arrangement of data constituting encoded data is not limited thereto.

Referring to FIG. 5, encoded data R, P may be composed of user data R containing information input by a user or generated by a system and parity P generated by ECC 150 to verify sufficient integrity of the user data R. Parity P for protecting the user data R may be calculated in the encoding pass, and the decoding pass may verify the integrity of the encoded data R, P using the parity P.

In some example embodiments, parity P may be a value generated by a linear block code for the user data R. The linear block code may be an ECC in the form of adding parity P, which is additional data used for error detection and correction, to the user data R. For example, the linear block code may include a Hamming code, SEC-DED, BCH, and the like. However, the type of the linear block code is not limited thereto.

For example, if the ECC is SEC-DED, the parity P generated by the SEC-DED may be composed of Hamming parity and global parity. The Hamming parity may be a parity generated by the Hamming code for the user data R. For example, if the size of the user data R is 32 bits, the size of the Hamming parity may be 7 bits. The global parity may be a bit added so that the sum of the bits of the encoded data becomes even or odd. For example, the global parity may be a value obtained by performing an XOR operation on all digits of the user data R and the parity P, and may have a size of 1 bit.

The encoder of ECC 150 may generate parity P corresponding to user data R. Conversely, the decoder of ECC 150 may verify sufficient integrity of user data R using the parity P included in the encoded data R, P. To maintain the integrity of data, the CPU may input data to at least one pipeline register after encoding it, and may verify sufficient integrity of data output from the pipeline register by decoding it.

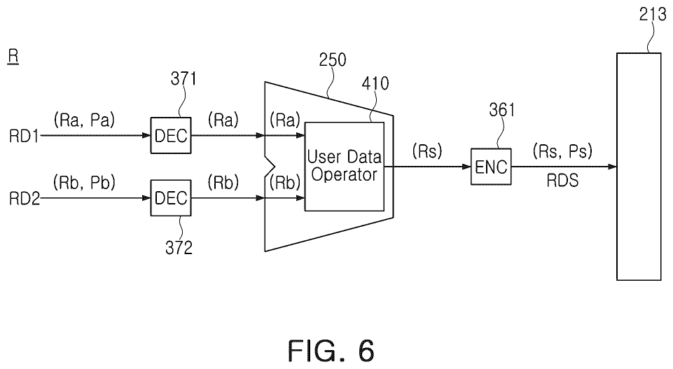

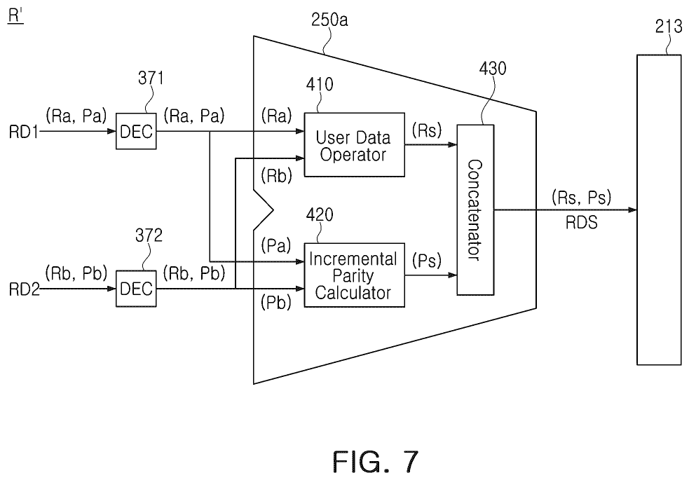

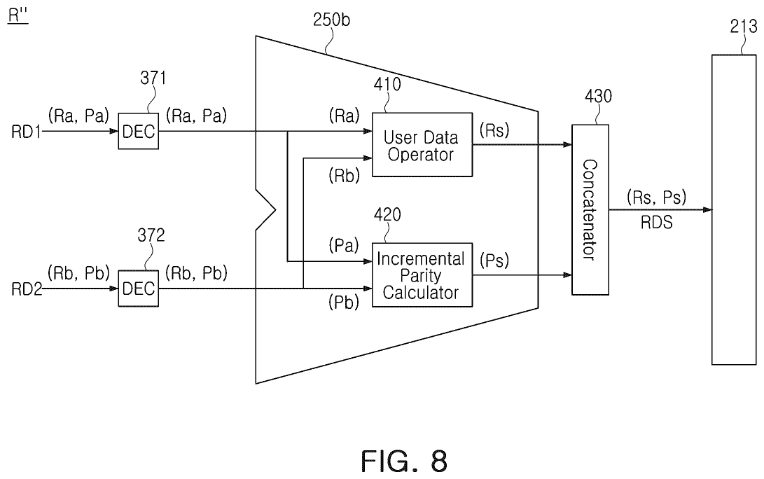

FIG. 6 is a drawing for illustrating the operation according to a comparative example different from the example embodiment, and FIGS. 7 and 8 may be drawings for illustrating the operation according to some example embodiments. FIGS. 6 to 8 may be drawings for the R region of the data path described above with reference to FIG. 4.

Referring to FIG. 6, the ALU 250 according to some example embodiments may receive the first read data RD1 and the second read data RD2 as operands RD1, RD2 according to the register store instruction. The ALU 250 may perform one or more arithmetic operation on the operands RD1, RD2 according to the input opcode and output an operation result value RDS. Although FIGS. 6 to 8 assume that the currently executing instruction is a register store instruction, the operation of the ALU 250, 250a, 250b is not limited thereto. For example, if the currently executing instruction is a memory store instruction or a memory load instruction, the operands received by the ALU 250, 250a, 250b may be a first read data RD1 including a base address and an offset OFF. For example, the user data Ra of the first read data RD1 may be the base address, and the user data Rb of the offset OFF may be a value corresponding to the difference the base address and the destination address. In addition, the ALU 250 may perform addition operations, and the like, on the user data Ra, Rb.

To maintain sufficient integrity of the data, the first read data RD1 and the second read data RD2 may be subjected to a parity check by the decoding pass 371, 372 before being input to the ALU 250. As described above with reference to FIG. 5, the read data RD1, RD2 may include the user data Ra, Rb and the parity Pa, Pb corresponding to the user data Ra, Rb. The decoding pass 371, 372 may detect and correct errors included in the user data Ra, Rb using the parity Pa, Pb, thereby obtaining sufficient integrity of the user data Ra, Rb. After the integrity of the user data Ra, Rb is verified by the decoding pass 371, 372, the user data Ra, Rb may be input to the user data operator 410 in the ALU 250 to perform an arithmetic operation.

To maintain sufficient integrity of the data, the operation result value of the ALU 250 may be encoded by the encoding pass 361 before being input to the EX/MEM pipeline register 213. For example, the operation result value RDS to which the parity result value Ps corresponding to the user data result value Rs is added may be input to the EX/MEM pipeline register 213.

For example, the EX stage where the operation is performed in the ALU 250 may take relatively longer time than the pipeline stages IF, ID, EX, MEM, WB. For example, if the data whose operation is completed is encoded after the actual operation is performed, the operation time may be further delayed. Accordingly, the period of the clock signal may be lengthened so that the pipeline stages IF, ID, EX, MEM, WB are each performed during one period of the clock signal.

Referring to FIGS. 7 and 8, the ALU 250a, 250b according to some example embodiments may not include the encoding pass 361 in the output stage compared to the ALU 250 described with reference to FIG. 6, and may further include an incremental parity calculator 420 and a concatenator 430.

In some example embodiments, referring to FIG. 7, the incremental parity calculator 420 and the concatenator 430 may be arranged inside the ALU 250a. In some example embodiments, referring to FIG. 8, the incremental parity calculator 420 and the concatenator 430 may be arranged outside the ALU 250b. Accordingly, the positions of the incremental parity calculator 420 and/or the concatenator 430 are not limited thereto.

The incremental parity calculator 420 may receive parities Pa, Pb from the decoded read data RD1, RD2. The incremental parity calculator 420 may calculate a valid parity result value Ps corresponding to the user data result value Rs using the parities Pa, Pb of the user data Ra, Rb when a linear operation is performed on the user data Ra, Rb by utilizing the linearity of the linear block code. For example, in the linear block code, the valid parity result value Ps corresponding to the user data result value Rs may be calculated using the parities Pa, Pb of the user data Ra, Rb. For example, linear operations may include arithmetic operations such as addition, subtraction, multiplication, division, or shifts.

In some example embodiments, when the ECC is SEC-DED and an addition operation is performed on the first user data Ra and the second user data Rb, an XOR operation may be performed on the first parity Pa and the second parity Pb to output a parity result value Ps corresponding to the user data result value Rs. For example, the incremental parity operation corresponding to the addition operation may be an XOR operation. For example, the first user data Ra may be 1011, the second user data Rb may be 0101, and an addition operation may be performed on the first user data Ra and the second user data Rb. In this case, the user data result value Rs may be 1110. The first Hamming parity and the first global parity calculated by the SEC-DED may be 010 and 0, respectively. For example, the first parity Pa may be 0100. The second Hamming parity and the second global parity calculated by SEC-DED may be 010 and 1. For example, the second parity Pb may be 0101. The parity result value Ps for the user data result value Rs may be 0001, which is the concatenation of the Hamming parity result value 000 and the global parity result value 1. From this, it may be confirmed that the parity result value Ps matches the value obtained by XORing the first parity Pa and the second parity Pb. Incremental parity operation methods using various arithmetic operations and shift operations, as well as addition operations, are performed using techniques from the art.

The concatenator 430 may merge the user data result value Rs and the parity result value Ps into one operation result value RDS. The operation of the concatenator 430 may take relatively less time than the encoding operation. The concatenator 430 may output the encoded operation result value RDS without a separate encoding operation after the linear operation is performed.

The processor according to some example embodiments may obtain the parity corresponding to the operation result value by performing the incremental parity operation while the ALU performs the linear operation. Therefore, the encoding operation after the linear operation is completed may be omitted. Therefore, the processor may perform the operation at relatively higher speed while maintaining fault tolerance.

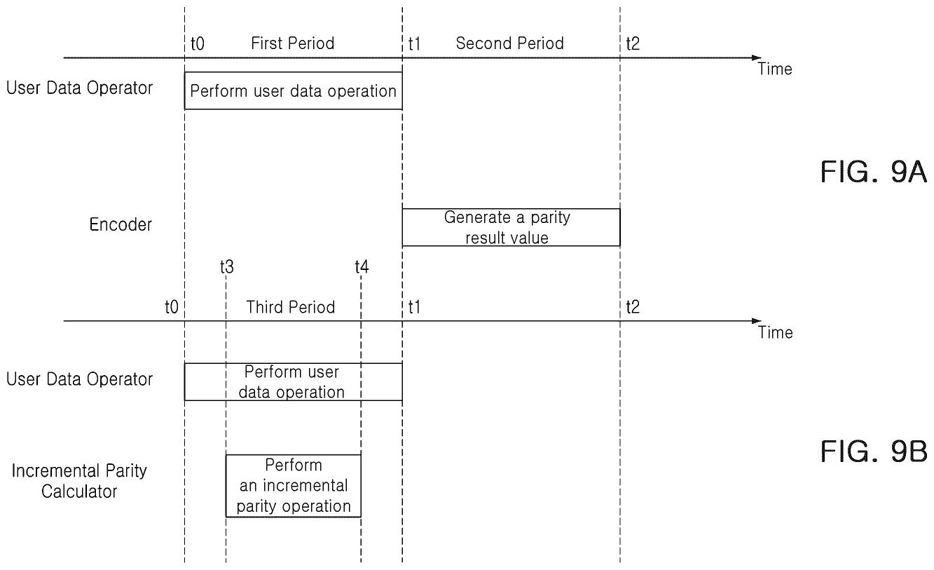

FIGS. 9A and 9B are timing diagrams illustrating the linear operation and incremental parity operation of the arithmetic logic unit according to some example embodiments. FIG. 9A is a timing diagram illustrating the arithmetic operation of the ALU 250 described with reference to FIG. 6. FIG. 9B is a timing diagram illustrating the arithmetic operation of the ALU 250a, 250b described with reference to FIG. 7 and FIG. 8.

Referring to FIG. 6 and FIG. 9A, during the first period t0 to t1, the user data operator 410 may perform a user data operation based on the user data Ra, Rb included in the decoded read data RD1, RD2. During the second period t1 to t2, the encoding pass 361 may generate a parity result value Ps based on the user data result value Rs. Accordingly, the ALU 250 may output the operation result value RDS after the operations of the user data operator 410 and the encoding pass 361 are both performed t2. For example, when ECC is SEC-DED and the size of the user data Ra, Rb is 32 bits, the size of the parity Pa, Pb may be 7 bits. In this case, the time taken by the ALU 250 to perform the arithmetic operation may be the operation time of the user data operator 410 (for example, log₂ 32) plus the calculation time of the encoding pass 361 (for example, log₂ 7).

Referring to FIGS. 7, 8, and 9B, during the first period t0~t1, the user data operator 410 may perform a user data operation based on the user data Ra, Rb included in the decoded read data RD1, RD2. While the linear operation is performed in the first period t0~t1, the incremental parity calculator 420 may perform an incremental parity operation during the third period t3~t4. Therefore, the operation result value RDS may be output after (e.g., immediately after or with minimal time delay) the time point t1 at which the linear operation is performed in the user data operator 410. For example, when ECC is SEC-DED and the size of user data Ra, Rb is 32 bits, the size of parity Pa, Pb may be 7 bits. In this case, the time required for the ALU 250a, 250b to perform the arithmetic operation may take as long as the operation time of the user data operator 410 (for example, log₂ 32). For example, since the incremental parity operation is performed together while the linear operation is performed in the ALU 250a, 250b, the encoded operation result value RDS may be output even if the operation result value is not input to the encoding pass 361 again as described with reference to FIG. 2. Therefore, the processor may perform the operation at high speed while maintaining the security of data.

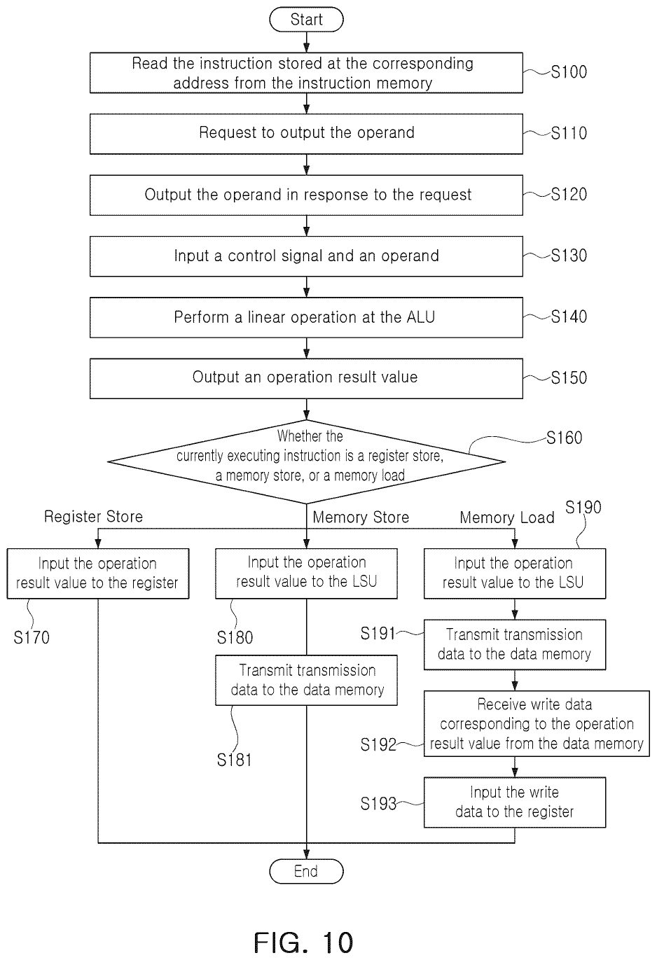

FIG. 10 is a flowchart provided to illustrate the operation of a processor according to some example embodiments for processing data.

As described above with reference to FIG. 3 and FIG. 4, the CPU core may divide a series of processes for performing operations into a plurality of pipeline stages IF, ID, EX, MEM, WB. The CPU core may perform operations for instructions such as memory load instruction, memory store instruction, or register store instruction.

Referring to FIG. 3, FIG. 4, and FIG. 10, first, the PC 220 may transfer the address of the instruction to be currently executed to the instruction memory 230, and read the instruction stored at the corresponding address from the instruction memory 230 (S100). In some example embodiments, if the instruction requested by the PC 220 is stored in the cache memory of the CPU, the instruction may be read from the cache memory instead of the instruction memory 230.

The register 240 may receive an instruction signal including the instruction from the instruction memory 230. The instruction may be decoded and separated into opcode and data for the operand. The register 240 may be input with data for the operand and may be requested to output the operand S110. The register 240 may output the operand in response to the request (S120).

In some example embodiments, if the instruction is a register store instruction, the data for the operand may include addresses RR1, RR2 of source registers where read data RD1, RD2 are stored. The source register among the plurality of registers 240 may be requested for the operand RD1, RD2. Each of the source registers may output the first read data RD1 and the second read data RD2 in response to the request.

In some example embodiments, if the instruction is a memory load instruction or a memory store instruction, the data for the operand may include an address RR1 and an offset OFF of a source register that provides a base address. The source register may be requested for the base address. The source register may output the base address in response to the above request.

The ALU 250 may input a control signal and an operand corresponding to the opcode (S130). The ALU 250 may perform a linear operation based on the input opcode and operand (S140). For example, the linear operation may include an arithmetic operation, a shift operation, and the like. The ALU 250 may output an operation result value RDS (S150).

Depending on whether the currently executing instruction is a register store instruction, a memory store instruction, or a memory load instruction (S160), the operation result value may be input to a different configuration. If the currently executing instruction is a register store instruction, the operation result value RDS may be written back and input to the register 240 (S170). If the instruction is a memory store instruction, the operation result value RDS may be input to the LSU 260 (S180). The LSU 260 may transmit transmission data DATA_T including the operation result value RDS to the data memory (S181), and the operation result value RDS may be stored in the data memory. If the command is a memory load instruction, the operation result value RDS may be input to the LSU 260 (S190). The LSU 260 may transmit transmission data DATA_T including the operation result value RDS to the data memory (S191). The LSU 260 may receive reception data DATA_R including write data WD corresponding to the operation result value RDS from the data memory (S192). The write data WD output from the LSU 260 may be written back and input to the register 240 (S193).

Among the operations S100 to S193, the operation S140 which is performed in the arithmetic logic unit may take relatively longer. According to some example embodiments, by omitting the encoding operation after the operation is completed in the operation of operation S140, the time required for operation S140 may be shortened or reduced.

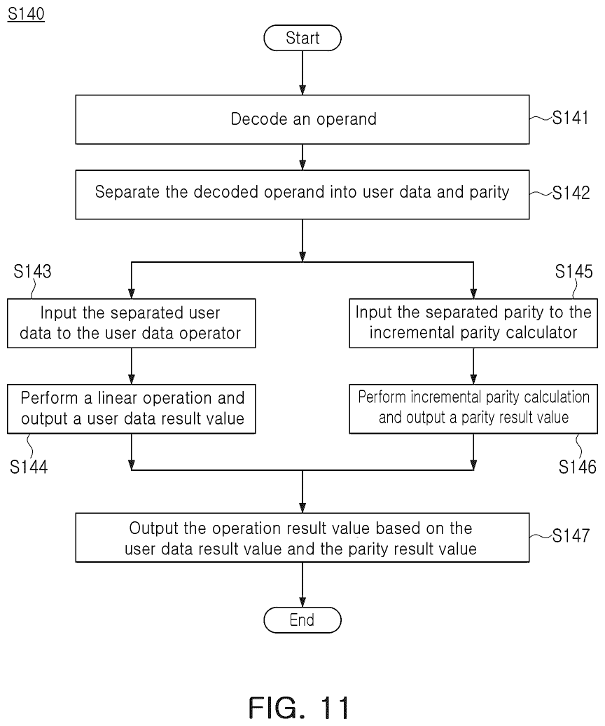

FIG. 11 is a flowchart provided to illustrate the operation of an arithmetic logic unit according to some example embodiments. FIG. 11 may be a flowchart of an operation S140 in which an operation is performed in an arithmetic logic unit in the flowchart illustrated with reference to FIG. 10 above.

Referring to FIG. 7 and FIG. 8 together, an operand may be decoded by a decoding pass 371, 372 before being input to an ALU 250a, 250b and sufficient integrity thereof may be verified (S141). The decoded operand may be separated into user data Ra, Rb and parity Pa, Pb (S142). However, as described above with reference to FIGS. 7 and 8, the operation S142 of separating user data Ra, Rb and parity Pa, Pb is not limited to its location, such as being performed outside or inside the ALU 250a, 250b.

The separated user data Ra, Rb may be input to the user data operator 410 (S143). The user data operator 410 may perform a linear operation based on the input user data Ra, Rb and output a user data result value Rs (S144). While the linear operation is performed, the separated parity Pa, Pb may be input to the incremental parity calculator 420 (S145). The incremental parity calculator 420 may perform incremental parity calculation based on the input parity Pa, Pb and output a parity result value Ps (S146). The parity result value Ps output by the incremental parity calculator 420 may be a parity result value Ps corresponding to the user data result value Rs output by the user data operator 410, as described above with reference to FIGS. 7 and 8.

The operations S145, S146 of the incremental parity calculator 420 according to some example embodiments may be performed while the operations S143, S144 of the user data operator 410 are performed. After the operation S144 of the user data operator 410 is completed, the user data result value Rs and the parity result value Ps may be combined by the concatenator 430 to output the operation result value RDS (S147). Since the operation S145, S146 of the incremental parity calculator 420 may be performed while the operation S143, S144 of the user data operator 410 is being performed, the parity result value Ps of the user data result value Rs may not be separately calculated at a different time.

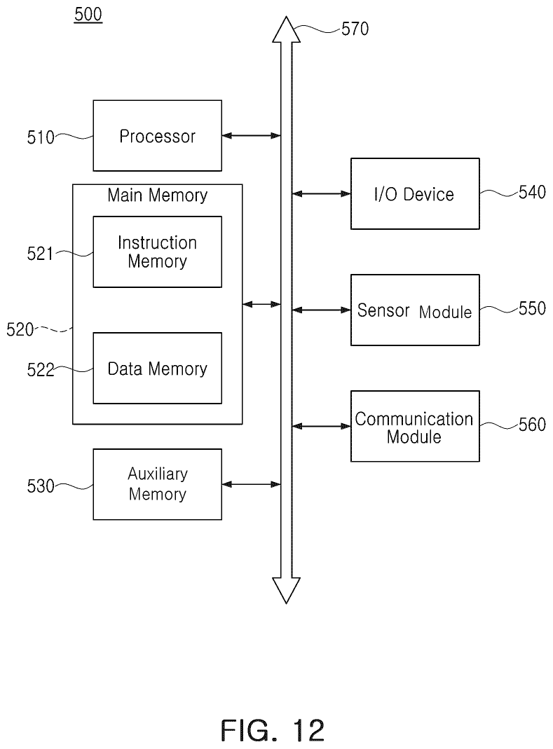

FIG. 12 is a diagram illustrating a system configuration according to some example embodiments.

Referring to FIG. 12, a system 500 according to some example embodiments may include a processor 510, a main memory 520, an auxiliary memory 530, an input/output device 540, a sensor module 550, a communication module 560, and a system bus 570.

The processor 510 may control the overall operation of each component of the system 500. The processor 510 may be a core component of the system 500 that controls the interpretation of input commands and the processing of operations, comparisons, and the like. of data stored in the system. The processor 510 may receive commands from other components through the system bus 570, decode the received commands, and process various types of arithmetic and/or logical operations or execute data processing according to the decoded commands.

According to some example embodiments, the processor 510 may include the ALU 250a, 250b described above with reference to FIGS. 7 and 8. The processor 510 including the ALU 250a, 250b is not limited to a CPU. For example, the processor 510 may be implemented as at least one of various processing units that perform computational operations, such as a microprocessor (MPU), a central processing unit (CPU), a single/multi-core processor, a graphic processing unit (GPU), an application processor (AP), and a digital signal processor (DSP).

The main memory 520 is a memory location that may move and execute a program or data from an auxiliary memory 530 when a program is executed, and the stored content may be preserved even when the power is turned off. The main memory 520 may include an instruction memory 521 and a data memory 522 as logical configurations. The main memory 520 may be the main memory 20 described above with reference to FIG. 2.

The instruction memory 521 may store instructions to be executed by the CPU, such as codes of executable files, call functions, and operation instructions. The instructions may be read through a PC. The data memory 522 may store data required for executing instructions, such as variable values, arrays, calculation results, and temporary data. Data read or modified in the middle of executing instructions through a PC may be stored in the data memory 522.

The auxiliary memory 530 may be a memory device for storing program codes or data. The auxiliary memory 530 is relatively slower than the main memory 520, but may have a relatively higher storage capacity and thus store a relatively higher amount of data. The auxiliary memory may include a nonvolatile memory device. For example, the auxiliary memory 530 may include a magnetic tape, a magnetic disk, a laser disk using light, a magneto-optical disk using both a magnetic field and light, a hard disk drive (HDD), a solid state drive (SSD), a universal serial bus (USB), a compact flash (CF) card, a secure digital (SD) card, a micro-SD (Micro-Secure Digital) card, a mini-SD (Mini-Secure Digital) card, a secure digital high capacity (SDHC) card, a memory stick card, a smart media card (SM), a multi-medica card (MMC), an embedded MMC (eMMC), an extreme digital (xD) card, and the like.

The input/output device 540 may receive a command or data from a user and transmit it to a processor or memory through a bus. The input/output device 540 may include standard input devices such as a computer keyboard, a mouse, or other pointing device, a touch pad, a joystick, or other data input devices. In addition, the input/output device 540 may include a graphic/display device, a computer screen, an audio speaker, a notification system, a Computer Aided Design/Computer Aided Machining (CAD/CAM) system, a video game station, or any other type of data output device. In some example embodiments, the input/output device 540 may be connected to the processor 510 via a peripheral interface.

The sensor module 550 may sense or receive a signal from outside the electronic device and convert the sensed or received signal into sensing data. The sensor module 550 may include at least one of various types of sensing devices, such as a microphone, an imaging device, an image sensor, a Light Detection and Ranging (LIDAR) sensor, an ultrasonic sensor, an infrared sensor, a biosensor, and a touch sensor.

The communication module 560 may include both a module that may be connected to a wired network and a module that may be connected to a wireless network. Wired network modules may include wired Local Area Network (LAN), Universal Serial Bus (USB), Ethernet, Power Line Communication (PLC), and the like. The wireless network module may include Infrared Data Association (IrDA), Code Division Multiple Access (CDMA), Time Division Multiple Access (TDMA), Frequency Division Multiple Access (FDMA), Wireless LAN, Zigbee, Ubiquitous Sensor Network (USN), Bluetooth, Radio Frequency Identification (RFID), Long Term Evolution (LTE), Near Field Communication (NFC), Wireless Broadband Internet (WiBro), High Speed Downlink Packet Access (HSDPA), Wideband Code Division Multiple Access (WCDMA), Ultra WideBand (UBD), and the like.

The system bus 570 may provide a communication path between components of the system. Components of the system may exchange data according to a bus format of the system bus. The system bus 570 may include a data bus, a control bus, and an address bus. The system bus 570 may have the same configuration as the system bus 30 described above with reference to FIG. 2.

As set forth above, according to some example embodiments, an arithmetic logic unit may perform an incremental parity operation on a parity corresponding to user data in advance while performing a linear operation on user data input as an operand. Accordingly, even if a separate encoding operation is not performed on the user data result value after the linear operation is completed, the processor may perform an operation at relatively higher speed while maintaining fault tolerance by outputting an encoded operation result value.

As described herein, any devices, systems, modules, portions, units, controllers, circuits, and/or portions thereof according to any of the example embodiments, and/or any portions thereof (including, without limitation, the CPU 10, the main memory 20, the instruction memory 22, the data memory 21, the CPU core 100, the plurality of registers 110, the control unit (CU) 130, the load/store unit (LSU) 140, the error correction coder (ECC) 150, the internal bus 160, the cache memory 170, the flag register (FR) 111, the program counter (PC) 113, the pipeline register 114, the accumulator (ACC) 115, the memory address register (MAR) 116, the memory buffer register (MBR) 117, the instruction register (IR) 118, the IF/ID pipeline register 211, the ID/EX pipeline register 212, the EX/MEM pipeline register 213, the MEM/WB pipeline register 214, the PC 220, the instruction memory 230, the register 240, the LSU 260, the sign expander 271, the shift circuit 272, adders 281, 282, the multiplexers 291 and 292, the encoding passes 361, 362, 363, 364, 365 and decoding passes 371, 372, 373, 374, 375, the user data operator 410, the incremental parity calculator 420, the concatenator 430, the system 500, the processor 510, the main memory 520, the auxiliary memory 530, the input/output device 540, the sensor module 550, the communication module 560, the system bus 570, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. An arithmetic logic unit comprising:
a user data operator configured to receive a first user data included in a first operand and a second user data included in a second operand, perform a linear operation on the first user data and the second user data, and output a user data result value of the linear operation; and
an incremental parity calculator configured to receive a first parity included in the first operand and a second parity included in the second operand, perform an incremental parity operation on the first parity and the second parity, and output a parity result value based on the incremental parity operation, wherein
the first parity is generated by performing error correction encoding on the first user data,
the second parity is generated by performing the error correction encoding on the second user data,
the parity result value is generated by performing the error correction encoding on the user data result value, and
the incremental parity operation is performed while the linear operation is being performed.

2. The arithmetic logic unit of claim 1, further comprising a concatenator configured to receive the parity result value and the user data result value and output an operation result value including the parity result value and the user data result value.

3. The arithmetic logic unit of claim 1, wherein the linear operation includes arithmetic operations and a shift operation.

4. The arithmetic logic unit of claim 1, wherein the first user data and the second user data are integers.

5. The arithmetic logic unit of claim 1, wherein the error correction encoding is performed by a linear block code.

6. A processor comprising:
an arithmetic logic unit configured to receive a first operand and a second operand and output an operation result value; and
an error correction coder including an encoder configured to perform error correction encoding and a decoder configured to perform error correction decoding, wherein
the arithmetic logic unit is configured to perform an incremental parity operation on a first parity included in the first operand and a second parity included in the second operand and output a parity result value, while performing a linear operation on first user data included in the first operand and second user data included in the second operand and outputting a user data result value,
the arithmetic logic unit is configured to output the parity result value and the user data result value as the operation result value,
the first parity is generated by error correction encoding the first user data, and
the second parity is generated by error correction encoding the second user data,
wherein the parity result value is generated by error correction encoding the user data result value.

7. The processor of claim 6, further comprising a concatenator configured to receive a user data result value obtained based on the linear operation and a parity result value obtained based on the incremental parity operation, and output the operation result value that is based on a combination of the user data result value and the parity result value.

8. The processor of claim 7, further comprising a load/store unit that is configured to output the operation result value and receive write data corresponding to the operation result value.

9. The processor of claim 6, wherein the decoder is configured to perform the error correction decoding on the first operand using the first parity and perform the error correction decoding on the second operand using the second parity.

10. The processor of claim 6, wherein the linear operation includes an arithmetic operation and a shift operation.

11. The processor of claim 6, wherein the first user data and the second user data are integers.

12. The processor of claim 6, wherein the error correction coder uses an error correction code including a linear block code, and
the encoder and the decoder are configured to perform an encoding operation and a decoding operation, respectively, using the linear block code.

13. A method of operating a processor comprising:
performing error correction decoding of a first operand using a first parity included in the first operand and performing error correction decoding of a second operand using a second parity included in the second operand;
performing a linear operation on a first user data included in the first operand and a second user data included in the second operand;
performing an incremental parity operation on the first parity and the second parity while performing the linear operation; and
combining a user data result value which is a result of the linear operation and a parity result value which is a result of the incremental parity operation to output an operation result value, wherein
the first parity is generated by error correction encoding on the first user data,
the second parity is generated by error correction encoding on the second user data, and
the parity result value is generated by error correction encoding on the user data result value.

14. The method of claim 13, further comprising:
reading the first operand and the second operand from a register; and
writing back the operation result value to the register.

15. The method of claim 13, further comprising:
reading the first operand from a register; and
transmitting the operation result value to a memory,
wherein the second operand is an offset.

16. The method of claim 15, further comprising:
receiving write data corresponding to the operation result value from the memory; and
writing back the write data to the register.

17. The method of claim 13, further comprising:
separating the first user data and the first parity from the first operand; and
separating the second user data and the second parity from the second operand.

18. The method of claim 13, wherein the linear operation includes an arithmetic operation and a shift operation.

19. The method of claim 13, wherein the first user data and the second user data are integers.

20. The method of claim 13, wherein the error correction decoding and the error correction encoding are performed based on a linear block code.
